(19) United States
(12) Patent Application Publication
(10) Pub. No.: US 2023/0172254 A1
(43) Pub. Date: Jun. 8, 2023

(54) Garlic Roller

(71) Applicant: Williams-Sonoma, Inc., San Francisco, CA (US)

(72) Inventor: Karl Edward Ludeman, Oakland, CA (US)

(21) Appl. No.: 18/062,779

(22) Filed: Dec. 7, 2022

Related U.S. Application Data
(60) Provisional application No. 63/287,303, filed on Dec. 8, 2021.

(51) Int. Cl. A23N 15/00

(52) U.S. Cl. CPC A23N 15/00

(57) ABSTRACT

A garlic roller has a base including a pair of side walls and a top panel that cooperatively define a chamber. A curved panel includes a cutting grate having multiple apertures. The curved panel is pivotally connected to the base so as to pivot between an open position and a closed position, with the curved panel enclosing the chamber when in a closed position. A closing mechanism releasably secures the curved panel in the closed position.

### CLAIM OF PRIORITY

This application claims the benefit of U.S. Provisional Application No. 63/287,303, filed Dec. 8, 2021, the contents of which are hereby incorporated by reference.

### FIELD OF THE INVENTION

The present invention relates generally to garlic rollers and, more particularly, to a garlic roller with an enclosed chamber for collecting pressed garlic.

### BACKGROUND OF THE INVENTION

Garlic rollers or rockers are valuable tools in the kitchen. A typical garlic roller or rocker uses downward pressure and a rocking motion, both provided by a user, to break up garlic cloves. A cutting grate breaks up the cloves and forces the pieces through the grate for collection in the device.

Conventional garlic rollers are open-sided with a handle spanning between ends of an arched cutting grate panel. After pressing several cloves, however, the user's fingers likely will come into contact with the collected garlic, which spills out of the open sides of the device. This may be undesirable. Additionally, cleaning can be problematic in that it is cumbersome to hold the handle and try to scoop out the chopped garlic.

A garlic roller designed with a convenient collection cavity that doesn't suffer from the above issues is desirable.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a garlic roller includes a base having a pair of side walls and a top panel that cooperatively define a chamber. A curved panel includes a cutting grate having a plurality of apertures. The curved panel is pivotally connected to the base so as to pivot between an open position and a closed position. The curved panel encloses the chamber when in a closed position. A closing mechanism releasably secures the curved panel in the closed position.

### BRIEF DESCRIPTION OF THE DRAWINGS

FIG. 1 is a perspective view of an embodiment of the garlic roller of the disclosure with a curved panel including the cutting grate in an open position.

FIG. 2 is side elevational view of the garlic roller of FIG. 1 with a curved panel including the cutting grate in a closed position.

FIG. 3 is a bottom elevational view of the garlic roller of FIG. 2.

FIG. 4 is a top perspective view of the garlic roller of FIGS. 2 and 3.

FIG. 5 is a bottom perspective view of the garlic roller of FIGS. 2, 3 and 4.

FIG. 6 is a perspective view of a second embodiment of the garlic roller of the disclosure with the curved panel including a cutting grate in a partially open position.

### DESCRIPTION OF EMBODIMENTS

The embodiments disclosed herein are for the purpose of providing a description of the present subject matter, and it is understood that the subject matter may be embodied in various other forms and combinations not shown in detail. Therefore, specific designs and features disclosed herein are not to be interpreted as limiting the subject matter as defined in the accompanying claims.

Garlic rollers or rockers are useful for pressing and/or cutting garlic. These devices alleviate the need to manually process garlic clove or cloves with a user's hands and common kitchen utensils, like knives.

In accordance with the present disclosure, a garlic roller is provided. More specifically, a garlic roller with an enclosed chamber for collecting pressed garlic is disclosed.

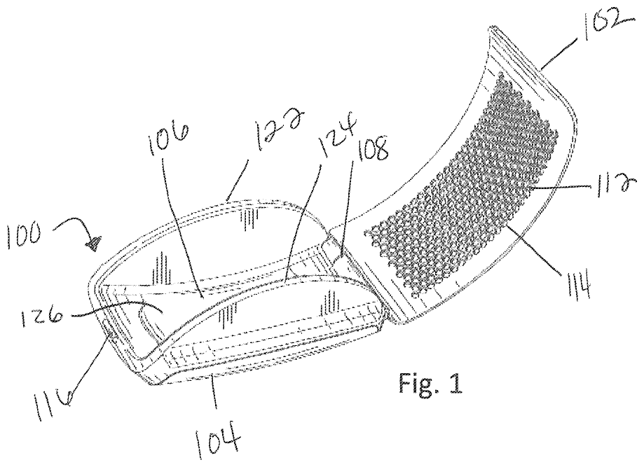

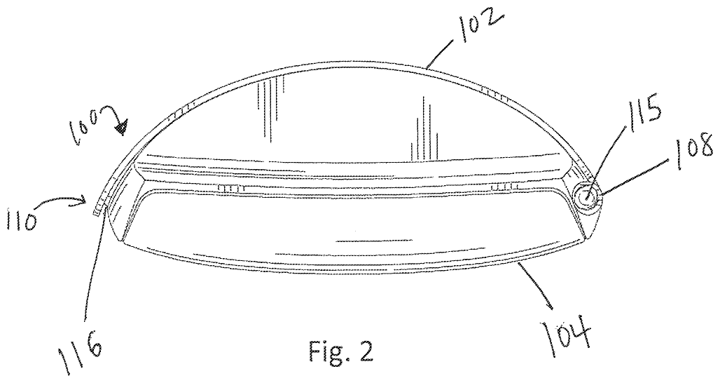

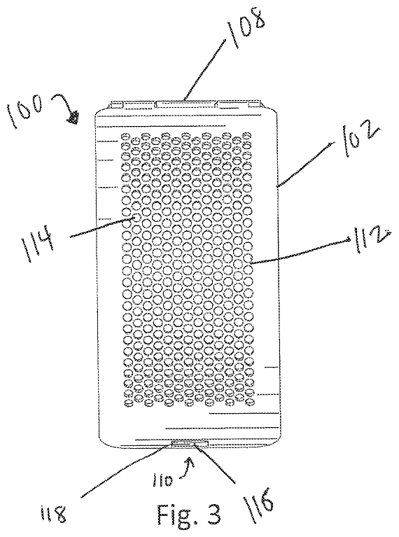

A first embodiment of a garlic roller of the disclosure is indicated in general at 100 in FIG. 1 in an open configuration. The garlic roller 100 includes a base 104 and a curved panel 102 with a chamber 106 that, as explained in greater detail below, can be enclosed, as illustrated in FIGS. 2-5.

The base may be constructed of a single material, or a combination of materials. The base may be plastic or metallic and may include a metal material such as stainless steel.

As shown in FIGS. 1, 3 and 5, the curved panel 102 includes a cutting grate 112. The cutting grate 112 may have a plurality of apertures 114. The apertures may be circular as shown in the figures, but can also include an oval, rectangular, triangular or any other known and useful shape. The apertures may be a single diameter or a plurality of diameters. The apertures can be arranged in a specific pattern. In an exemplary embodiment, and as shown in the FIGS. 1, 3 and 5, the apertures may be arranged in offset rows.

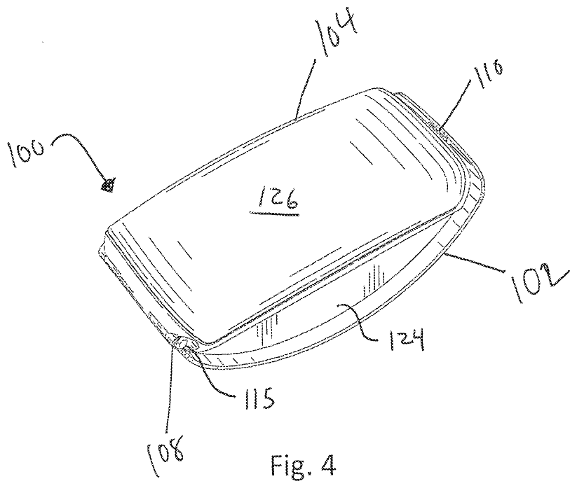

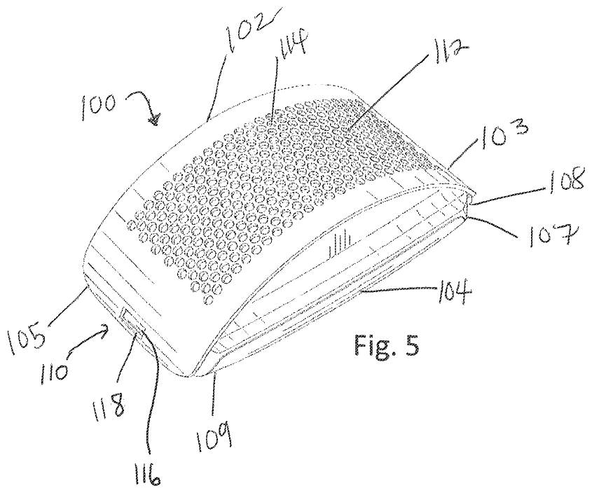

With reference to FIG. 5, the curved panel 102 and the base 104 are connected at a joint 108 at the first ends 103 and 107 of the curved panel and base. Joint 108 may be any applicable hinge or pivoting joint known in the art. Joint 108 pivotally connects the curved panel 102 and the base portion 104. As illustrated in FIGS. 2 and 4, the pivot joint may include a pin 115. The hinge or joint 108 allows for pivoting movement of the curved panel 102 with respect to the base 104 about pin 115, so that the curved panel 102 pivots between the closed position illustrated in FIGS. 2-5 and the open position illustrated in FIG. 1. The curved panel 102 may be constructed at least partially of a metal or metallic material. In a preferred embodiment, the curved panel is constructed of stainless steel.

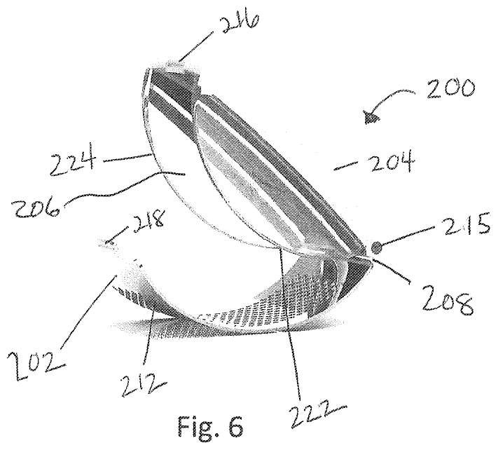

With reference to FIG. 5, at the second ends 105 and 109 of the curved panel and the base, there may be a closing mechanism, indicated in general at 110 in FIGS. 2, 3 and 5, for releasably latching the curved panel 102 in the closed position illustrated in FIGS. 2-5. The closing mechanism may be any applicable mechanism and can releasably join the curved panel 102 and base 104 at second ends 105 and 109 (FIG. 5). As shown in FIGS. 1-5 the closing mechanism may include a protrusion 116 on the base 104 and a slot 118 on the curved panel 102 that releasably receives the protrusion. More specifically, the curved panel 102 may flex slightly so that the protrusion 116 may be pulled out of the slot 118. A recess or notch may be substituted for slot 118. Alternately, as illustrated by the garlic press 200 of FIG. 6, described in greater detail below, the curved panel 202 may include a protrusion 218 and the base 204 may include a recess or notch 216. Alternatively, as further non-limiting examples, a magnetic latching arrangement or a pivoting hook/catch arrangement may be used.

With reference to FIGS. 1 and 4, the base 104 includes a pair of side walls 122 and 124 and a top panel 126 that cooperate to form a chamber 106 (FIG. 1). Top panel 126 serves as a handle by which the user may grip the garlic roller during use, and thus may be contoured, as illustrated in FIGS. 2 and 4, to facilitate gripping. When the curved panel 102 is in the closed position illustrated in FIGS. 2-5, the chamber 106 is enclosed.

As illustrated, the side walls 122 and 124 can include curved edges to conform to the curved panel 102 when the curved panel is in the closed position. The walls 122 and 124 can be plastic, but can also be metal or a combination of plastic and/or metal with other materials. The walls 122 and 124 may also be recessed from the lateral edges of the base and curved panel to allow for easier gripping of the device.

In an alternative embodiment, illustrated in FIG. 6, the side walls 222 and 224 of the garlic roller 200 are clear or transparent. As a result, a user may see through the side and into the chamber 206. Components of the embodiment of FIG. 6 are numbered similarly to their corresponding components of the embodiment of FIGS. 1-5.

In use, a user grips the top panel 126 and places the curved panel 102 of the garlic roller, when in the closed position of FIGS. 2-5 with the garlic roller in the orientation of FIG. 4, on top of a garlic clove or cloves arranged on a surface, such as a countertop or tabletop. The user then presses the garlic press down on the garlic clove or cloves and moves the garlic press in a rocking motion so that the curved panel 102, and thus the cutting grate 112, repeatedly rolls over the garlic clove or cloves. As a result, garlic from the garlic clove or cloves will pass through the apertures 114 of the cutting grate 112 of the device and into the chamber 106. The garlic will then be retained in the device until pressing is complete. When the pressing is complete, the user rotates the device into an orientation such as the orientation illustrated in FIG. 1. The curved panel 102 may then be pivoted from the closed position to the open position illustrated in FIG. 1. A user can then remove the pressed garlic from the chamber, or invert the garlic roller and dump the garlic out, for use.

While the preferred embodiments of the invention have been shown and described, it will be apparent to those skilled in the art that changes and modifications may be made therein without departing from the spirit of the invention.

What is claimed is:

1. A garlic roller comprising:
a base including a pair of side walls and a top panel that cooperatively define a chamber;
a curved panel including a cutting grate having a plurality of apertures;
said curved panel pivotally connected to the base so as to pivot between an open position and a closed position, said curved panel enclosing the chamber when in a closed position;
a closing mechanism configured to releasably secure the curved panel in the closed position.

2. The garlic roller of claim 1, wherein the closing mechanism comprises a protrusion and a corresponding notch, slot or recess.

3. The garlic roller of claim 2, wherein the protrusion is located on the curved panel and the notch, slot or recess is located on the base.

4. The garlic roller of claim 2, wherein the protrusion is located on the base and the notch, slot or recess is located on the curved panel.

5. The garlic roller of claim 1, wherein the side walls are clear.

6. The garlic roller of claim 1, wherein the side walls are transparent.

7. The garlic roller of claim 1, wherein the apertures are circular.

8. The garlic roller of claim 1, wherein the apertures are arranged in a pattern of offset rows.

9. The garlic roller of claim 1, wherein the curved panel is formed from a metallic material or metal.

10. The garlic roller of claim 9, wherein the curved panel is formed from stainless steel.

11. The garlic roller of claim 1, wherein the walls are recessed from the lateral edges of the curved panel and base.

12. The garlic roller of claim 1, wherein the top panel of the base is contoured.

13. The garlic roller of claim 1, wherein the base and curved panel are pivotally connected with a joint including a pin.

14. The garlic roller of claim 1 wherein the side walls include curved edges.
